(19) United States
(12) Patent Application Publication
(10) Pub. No.: US 2002/0062307 A1
(43) Pub. Date: May 23, 2002

(54) Method for generating a database of molecular fragments

(75) Inventors: Richard James Gilbert, London (GB); William A. Bains, London (GB); John Caldwell, London (GB)

Correspondence Address: SUGHRUE MION, PLLC, 1010 EL CAMINO REAL, SUITE 360, MENLO PARK, CA, 94025, US

(73) Assignee: AMEDIS PHARMACEUTICALS LTD, London (GB)

(21) Appl. No.: 09/992,440

(22) Filed: Nov. 16, 2001

(30) Foreign Application Priority Data
Nov. 17, 2000 (GB) 0028157.6

(51) Int. Cl. G06F 7/00

(52) U.S. Cl. 707/1

(57) ABSTRACT

A method is provided of generating a database of molecular fragment data defining parts of molecular structures, from a data set containing data describing predetermined molecular structures. The method comprises:

a) selecting first and second molecular structure data defining first and second molecular structures respectively from the data set;

b) comparing the selected data to determine molecular fragment data which defines at least part of a molecular structure common to each of the first and second molecular structures;

c) storing the determined molecular fragment data in the data set; and,

d) repeatedly performing steps (a) to (c) wherein either of the first or the second molecular structure data is selected from either the predetermined molecular structure data or the molecular fragment data determined in step (b) such that the resultant data set comprises a database containing the molecular fragment data.

### FIELD OF THE INVENTION

The present invention relates to a method of generating a database of molecular fragments, for example the molecular fragments relating to drug molecules such as for use in the modelling of a target biological characteristic.

### BACKGROUND TO THE INVENTION

The effect of new and existing molecules upon biological systems is of great importance, in particular with respect to producing new drugs for the treatment of disease.

The conventional approach to the development of new drugs has been the synthesis of large numbers of new molecules, followed by the selective testing of the most promising candidates in a series of experimental stages. Such experiments attempt to quantify a particular biological activity of interest for each molecule as this represents the effectiveness of the molecule for its intended purpose. However, experimentation is costly and time consuming and therefore it is particularly desirable to replace experimentation to an extent with appropriate modelling. One method of doing this is to model Quantitative Structure-Activity Relationships (QSAR).

The aim of QSAR modelling is to predict a biological activity of interest for previously untested molecules. The predictions are made on the basis of “physicochemical descriptors”. These are physical or chemical properties of the molecules which may be determined or computed.

A number of powerful modelling methods are available for use in prediction of the biological activity of interest from calculated or measured molecular properties. These methods include genetic programming, artificial neural networks and other techniques such as principal component analysis.

One of the primary limitations upon such methods is in its generalisation to predict complex biological characteristics such as oral bioavailability, organismal disposition. Such characteristics are likely to be the result of the interaction of the (drug) molecule with many others in the body.

The availability of high performance computers now allows complex relationships to be established within modelling data in a reasonable time. However, for complex biological characteristics, limitations are caused in part by the rather incomplete description of the molecules themselves that has been used in conventional methods. In particular, such limitations are manifested in the predictive power of models generated upon the modelling data.

There is therefore a desire to produce a method of generating an improved modelling data set, such that the factors influencing complex biological characteristics can be more readily identified.

### SUMMARY OF THE INVENTION

In accordance with a first aspect of the present invention we provide a method of generating a database of molecular fragment data, the molecular fragment data defining at least parts of a number of molecular structures, from a data set retained within a store, the data set containing predetermined molecular structure data defining a number of predetermined molecular structures, the method comprising:

a) selecting first and second molecular structure data defining first and second molecular structures respectively from the data set;

b) comparing the selected first and second molecular structure data to determine molecular fragment data, wherein the molecular fragment data defines at least part of a molecular structure common to each of the first and second molecular structures;

c) storing the determined molecular fragment data in the data set; and,

d) repeatedly performing steps (a) to (c) wherein either of the first or the second molecular structure data is selected from either the predetermined molecular structure data or the molecular fragment data determined in step (b) such that the resultant data set comprises a database containing the molecular fragment data.

With the method of the present invention, models subsequently run upon the generated database can therefore effectively consider a new kind of descriptor in the form of fragments that are common to at least two molecules of the data set of predetermined molecules. Whereas in the past some chemical groups have been considered as descriptors due to their known functionality, the present method makes no assumptions about underlying chemistry or its effects.

In particular the present method determines molecular fragments that are actually found within the molecules of the data set. Therefore time is not wasted in considering entities which are not present. There is also great versatility in that the method is not limited to any particular types of molecular structures.

Furthermore, the fragments defined by the data within the database determined according to the present invention, need not even be single entities of bonded atoms or molecules and indeed may represent dispersed fragments of molecular structure.

The database therefore provides the potential for improved data upon which subsequent modelling can be performed. This data may advantageously be used alongside data produced in accordance with known descriptors. These known methods typically utilise physico-chemical data relating to the molecules. Examples of these include partial atomic charges, electro/nucleophilic superdelocalizabilities, dipole moments, Van der Waals volume, surface area, molecular weight, melting point and principal moments of inertia.

Advantageously the present invention considers the molecular fragments as if they were molecular structures. The molecular “fragments” may in fact comprise complete structures of molecules although typically they are actually substructure fragments comprising one or more atoms and/or bonds.

It will be appreciated that there may be many different molecular fragments which can be identified as common structures between two molecules. All of these fragments can be considered although preferably only the maximum common structure common to the first and second molecular structures is determined during each comparison in step (b). This will generally be a maximum common substructure.

As has been suggested, the fragments themselves need not be considered as wholly connected entities of atoms and bonds, although preferably only single connected entities are considered. This function may be provided by the comparison technique used and the representation by which the molecular structures are expressed. Typically the use of a maximum common substructure limitation along with that of connected fragments reduces the total number of processing steps required to perform the method for a particular data set. The number of steps is also dependent upon the size of the original data set and the similarity between the molecules within it.

Preferably the method further comprises a step of comparing the molecular fragment data determined in step (b) with the molecular structure data in the data set and subsequently storing the determined molecular fragment data only if an identical molecular structure is not already present within the data set. This advantageously prevents the unwanted duplication of molecular structures. A fast method of achieving this is by basing the comparison upon the molecular masses of the corresponding molecular fragment under consideration and the molecular structure respectively.

If the fragment mass is found to be unique then the fragment structure can be stored whereas if one or more molecular structures with an identical mass are found, then a comparison between their structures can be performed.

Typically a comparison is made between all of the molecular structures in the data set and the number of such molecular structures generally increases as the method is performed. However, preferably unnecessary comparisons are avoided by, for a particular molecular fragment, generating and monitoring data identifying the first or second molecular structure data which has been involved in previous comparisons which have resulted in the determination of that particular molecular fragment data.

These resultant data are preferably stored as part of the molecular fragment data. Effectively a “family tree” identifying the parent molecular structures is therefore retained with the molecular structure data in each case. Typically this takes the form of a “parent list”.

Therefore, if the determined molecular fragment is found to be identical to a molecular structure already present within the data set, the identifying data (parent list) is added to the data defining that molecular structure that is already present within the data set.

A convenient method of performing the comparison step (b) of the first aspect of present invention is by using a graph theory method. Typically such a method comprises:

i) converting the first and second molecular structure data to first and second coloured graphs;

ii) determining a docking graph from the first and second graphs;

iii) identifying at least one clique within the docking graph; and

iv) converting each clique identified into molecular fragment data.

An efficient method of representing the molecular structures using such graphs is to represent bonds as graph nodes and atoms as graph edges. The graphs are coloured to take into account the various atom and bond types, and the chemical contexts of each atom.

Preferably the method therefore iteratively makes “pairwise” comparisons between data defining each of the original molecular structures; each of the original molecular structures with any molecular fragments determined at any time; and between each of any molecular fragments determined any time with any other molecular fragments determined at any time (subject to any omissions due to parent considerations).

Therefore the method preferably further comprises ranking the molecular structure data in the data set according to the frequency with which molecular structures identical to each particular molecular structure have been determined, and discarding the molecular structure data defining molecular structures which occur less frequently than a predetermined frequency threshold. This is because in many cases structure fragments that are only present within very small number of molecules (such as two) are unlikely to provide any useful information for modelling and are therefore discarded. Therefore only a number of the molecular fragment data are typically retained within the database.

Once the molecular fragment data have been determined they are preferably compared with the predetermined molecular structures in the original data set. Preferably the method therefore further comprises:

f) comparing the molecular fragment data in the database with the molecular structure data defining each of the predetermined molecular structures; and

g) determining the frequency of occurrence of each molecular fragment within each predetermined molecular structure.

Generally each of the predetermined molecular structures within the data set is compared with each of the molecular fragments in the database to determine whether or not each particular fragment it present. It is also possible that some molecular fragments may be present a number of times within a molecule and the frequency of such occurrences may also be determined. Some methods also allow the determination of fractional (non-integer) frequencies of occurrence which may be determined based upon the fraction of a particular molecular fragment which is present within a particular molecular structure. Preferably, the frequency of occurrence is determined for a particular predetermined molecular structure by:

i) selecting the molecular structure data defining the particular predetermined molecular structure;

ii) selecting molecular fragment data representing a particular molecular fragment from the data set;

iii) comparing the selected molecular structure data and the molecular fragment data to determine common structure data representing the structure common to the predetermined molecular structure and the selected molecular fragment;

iv) determining the amount of the molecular fragment structure that the common structure data represents;

v) removing the determined common structure data from the predetermined molecular structure data; and

vi) repeatedly performing steps (iii) to (v) until no further common structure data is determined.

Preferably a graph theory method is used in the comparison step (iii) above.

A second aspect of the present invention provides a method of determining a relationship between the presence of a number of molecular fragments in a number of molecular structures and a biological target characteristic of the molecular structures, the method comprising:

obtaining a modelling data set comprising data defining the molecular structures of a number of known molecules and corresponding known biological target characteristic data defining a common biological target characteristic for each molecule;

obtaining a database of molecular fragments data generated using a method according to the first aspect of the present invention;

obtaining data describing the presence of the molecular structures defined by the molecular fragment data, within the known molecules of the modelling data set; and,

determining a relationship between the data describing the presence of a number of the molecular fragments within the known molecules of the modelling data set and the common biological target characteristic data.

The second aspect of the present invention therefore provides a method of using the database of molecular fragments generated in accordance with the first aspect, to determine a relationship between a number of known molecules and a biological target characteristic common to the known molecules. This relationship is determined using data describing the presence of the molecular fragments within the known molecules. In one example, such data is obtained as part of the first aspect of the present invention.

Typically a number of the known molecules have identical structures to a number of the molecular structures used in the generation of the molecular fragment data. In general each of the known molecules will have an identical structure to those molecular structures so used.

The relationship is typically determined using a numerical modelling method such as genetic programming or neural network methods. Other modelling methods such as principal component analysis may also be used. The relationship will generally take a form determined by the modelling method used, such as an algorithm or equation.

In accordance with a third aspect of the present invention we provide a computer implemented method of generating predicted biological target characteristic data for a target molecule, the method comprising:

obtaining target molecular structure data defining the molecular structure of the target molecule;

obtaining the relationship generated in the method according to the second aspect of the present invention;

processing the target molecular structure data to generate target fragment data describing the presence within the target molecule, of the molecular structures defined by the molecular fragment data used in the obtained relationship; and,

using the obtained relationship and the target fragment data to generate biological target characteristic data for the target molecule.

The method of the third aspect of the invention therefore generates biological target characteristic data for a target molecule based upon the determined relationship and data describing the presence of the molecular fragments within the structure of the known molecule.

Generally the molecular structure of the target molecule is different to the molecular structures of the known molecules or the molecules used in the generation of the molecular fragment data. Therefore the target molecule will typically not have been used in any of the methods described above. The processing of the data describing the target molecule will typically involve a similar process to that used in obtaining data describing the presence of the molecular fragments in the molecules (for the purposes of determining the relationship).

Typically the determined biological target characteristic will be a numerical value for a particular biological property.

In the case of methods which determine fractional (non-integer) frequencies of occurrence of molecular fragments within the molecules of a given data set, it will be appreciated that potentially any molecular fragments may be used rather than those specifically determined using the method according to the first aspect of the invention.

Accordingly, a fourth aspect of the present invention provides a method of determining a relationship between the presence of a number of molecular fragments in a number of molecular structures and a biological target characteristic, the method comprising:

obtaining a modelling data set comprising data defining the molecular structures of a number of known molecules and corresponding known biological target characteristic data defining a common biological target characteristic for each molecule;

obtaining a database of molecular fragment data;

obtaining data describing the frequency of occurrence of a number of the molecular structures defined by the molecular fragment data, within the known molecules of the modelling data set wherein the data contains at least one non-integer frequency of occurrence; and,

determining a relationship between the data describing the frequency of occurrence of the molecular fragments within the known molecules of the modelling data set, and the common biological target characteristic data.

The database of molecular fragment data can be therefore generated by any means. Typically, as before, at least one non-integer frequency of occurrence is determined for the molecular structure of a particular known molecule by:

i) selecting the molecular structure data defining the particular known molecule;

ii) selecting molecular fragment data representing a particular molecular fragment from the database;

iii) comparing the selected molecular structure data and the molecular fragment data to determine common structure data representing the structure common to the predetermined molecular structure and the selected molecular fragment;

iv) determining the amount of the molecular fragment structure that the common structure data represents;

v) removing the determined common structure data from the predetermined molecular structure data; and

vi) repeatedly performing steps (iii) to (v) until no further common structure data is determined.

Preferably the comparison step (iii) is performed using a graph theory method as this is convenient for determining non-integer frequencies of occurrence Generally, a number of the known molecules will contain identical structures to a number of the molecular structures used in the generation of the molecular fragment data. The step of determining the relationship is typically performed using a numerical model.

The relationship generated in the manner described above (using non-integer frequencies of occurrence) can then be used in generating biological target characteristic data.

In accordance with a fifth aspect of the present invention a computer 15 implemented method of generating biological target characteristic data for a target molecule, comprises:

obtaining target molecular structure data defining the molecular structure of the target molecule;

obtaining the relationship generated in the method according to the fourth aspect of the invention;

processing the target molecular structure data to generate target fragment data describing the presence within the target molecule, of the molecular structures defined by the molecular fragment data used in the obtained relationship wherein the presence includes at least one non-integer frequency of occurrence; and,

using the obtained relationship and the target fragment data to generate biological target characteristic data for the target molecule.

Preferably in this case, the molecular structure of the target molecule is different to the molecular structures of the known molecules or the molecules used in the generation of the molecular fragment data.

Typically any of the aspects of the invention, will be implemented using a system such as a computer under the control of a computer program comprising program code means adapted to perform the method. The computer program may be typically embodied on a computer readable medium. The database will also be typically embodied on a computer readable medium.

Such a system described above may further comprise an input means to enable a user to control the system and enter data for use by the computer program. Typically such data will comprise molecular characteristics data relating to new molecules such as a target molecule. In each case the system may be provided with communication means in order to allow the user to control and access the system from a remote location, for example using the Internet. All aspects of the present invention may of course be implemented upon separate computer systems of for example a database supplier and a customer. These methods may be each performed as a service by a supplier. A customer may therefore only provide details of the molecular structure of a target molecule for which a value of the biological target characteristic is desired.

### BRIEF DESCRIPTION OF THE DRAWINGS An example of a method for generating a database of molecular fragments will now be described with reference to the accompanying drawings, in which:

FIG. 1 is a flow diagram overview of the example;

FIG. 2 shows a molecular fragment as the maximum common substructure of two molecules;

FIG. 3 illustrates the generation of numerous molecular fragments; and

FIG. 4 illustrates a database generated according to the example.

### DETAILED DESCRIPTION

The object of the example is to generate a database of data defining molecular fragments. These molecular fragments are structures of bonds and atoms that are common to at least two molecules of a predetermined molecular data set. The predetermined data set contains data defining the structures of the predetermined molecules which are typically drug molecules. The purpose of generating the database is to use a number of the molecular fragments as descriptors in the modelling of one or more biological characteristics exhibited by the molecules. The method in this case is performed upon a high performance computer system.

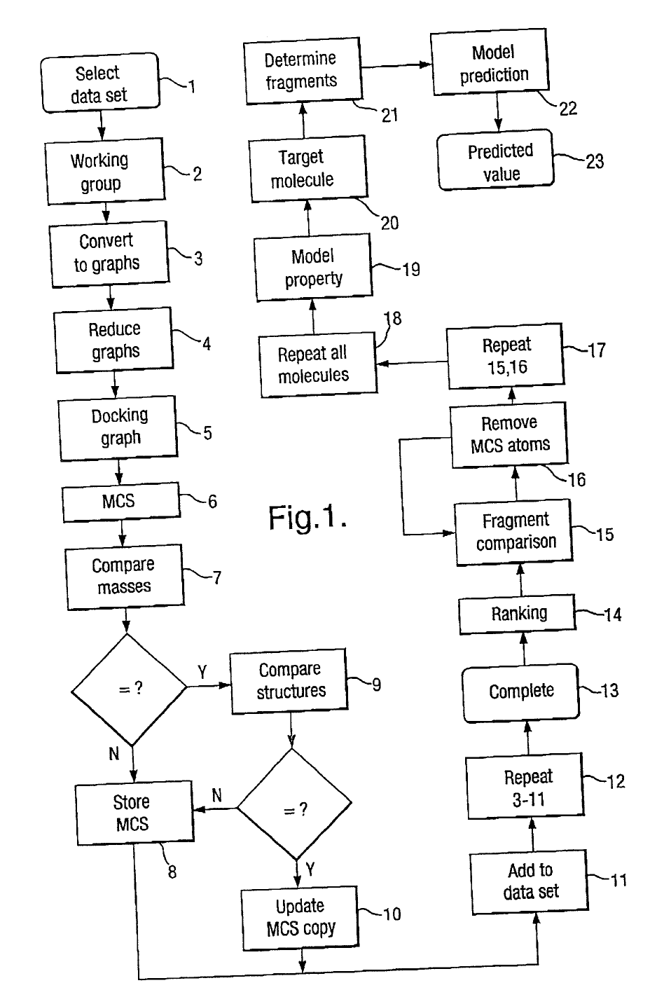

Referring to FIG. 1, the first step in this example is the selection of the data set of molecules upon which the method will be performed. The choice of the data set is dependent upon the intended purpose of the subsequent modelling to be performed upon the molecular fragments identified. For example, one data set might contain all known molecular structures having antibiotic properties and another data set might contain all molecules used in the treatment of Alzheimer's disease.

Whilst specific data sets of specialised molecules may be used to deduce the active parts of molecules for highly specialised properties, more general data sets may alternatively be used for modelling other more general properties. The method described here is equally applicable to either scenario.

For example, a large data set having a wide range of drug molecules developed for different purposes, may be used in studying fragments of molecules which influence a general property such as the ability of the molecule to pass through the blood-brain barrier.

A molecular data set is first selected at step 1 of FIG. 1. In this example, the data comprising the description of each molecule is held in the form of a file in a memory device of the computer system. Any suitable file format can be used and examples include “mol” files (Molecular Designs Limited), “alc” files (Tripos Inc) and “c3d” files (CambridgeSoft)”. The file format of the present example also uses the same format to store the structures of any molecular fragments that are identified. The structures may be considered in terms of either two or three dimensional structures.

A data set may comprise typically a few hundred molecules although virtually any number of molecules could be used. By way of example only, the data set in this example contains about 300 molecules.

Because this method generates a very large number of molecular fragments from a relatively small number of molecules, a working area is defined in the computer to contain any structures (molecules or fragments) currently under consideration. This keeps the structures separate from the original data set in order to speed their processing. In step 2, each of the 300 or so molecules are therefore copied to the working area as a working group.

The next stage involves the specific analysis of the structures of pairs of these molecules to deduce the maxi mum common substructure (MCS) between each pair. This is performed for each pairwise combination of the molecules within the working group. The steps involved in each comparison are now described with reference to the first pairs of molecules considered by the process.

At step 3, a first pair of molecules from the working group is selected and the structure of each of these molecules is converted into a “graph” according to graph theory. The graphs comprise nodes and edges, and the nodes of the graphs are chosen to represent bonds within the molecules, with edges representing atoms. This reduces the size of the graph considerably with respect to an alternative possible arrangement in which nodes are used to represent atoms and edges as bonds.

Each of the graphs is “coloured” as the nodes and edges represent various types of bonds and atoms. This is achieved by considering each atom in the molecular structure. The number of bonds to that atom is evaluated and then the type of bonding involved is deduced (for example single or double bonding). The atomic number of the atom at the end of each bond is determined to define the atom type and then finally the chemical context of the atom is assessed.

The chemical context provides information upon the environment surrounding the atom, particularly in terms of the atoms or groups to which it is bonded. For example the carbon atom at the centre of an ethylene group would have a different chemical contact to a carbon atom in a carbonyl group despite both atoms having two single and one double bond. The chemical context is then deduced from a suitable look-up table.

At step 4, each of the two coloured graphs for the molecules are “reduced” in order to generate corresponding reduced graphs, again according to graph theory. These reduced graphs are effectively tables of distances between each node in terms of the number of edges between them. The shortest paths between the nodes are stored in a connectivity table. Therefore these reduced graphs represent the minimum graphs describing each molecule.

Having reduced the graphs, a “docking graph” is created at step 5, by analysing the two reduced graphs (one for each molecule). The docking graph represents the structures that are common to the two reduced graphs. In reality these are represented as the intersection of two matrices. Common (sub)structures are defined by matches in both colour and distances for various nodes and edges. This can be thought of as picking a bond in the first molecule and one in the second molecule, comparing them and if they connect similar atoms, then going on to look at the other bonds of those atoms, comparing those and so on such that the structures of the two molecules are searched fully.

This method locates all substructures that are common to the pair of molecules and in many cases of course there are many such substructures which are common to the molecular pair. Typically drug molecules contain about 80 fragments having of at least 3 atoms.

Although each of these substructures could be stored and used later on as fragments, in the present example the substructures are then searched at step 6 in order to identify the maximum common substructure (MCS) within these fragments. A suitable method for achieving this is described in “Algorithm 457: Finding all cliques of an undirected graph”, C. Bron and J. Kerbosh, Communications of the ACM, Vol. 16, No. 9, 1973, pages 575 to 577.

The Bron and Kerbosh method is one of a number of possible methods for performing this step and this method has the added advantage of providing the capability of identifying either connected or unconnected areas of maximum common substructure. In the present case only connected areas of MCS are used, that is structures in which all the atoms and bonds are attached together via one or more other atoms or bonds, and not spaced apart for example in two or more unconnected regions. An unconnected MCS could also be used with this method but by using a connected MCS, the method is simplified in terms of processing, as it reduces the number of substructures considered.

Having found the maximum common substructure, this is then converted back into a file representation by a comparison with one of the original coloured graphs of the two parent molecules from which the substructure is generated. An MCS fragment is therefore generated.

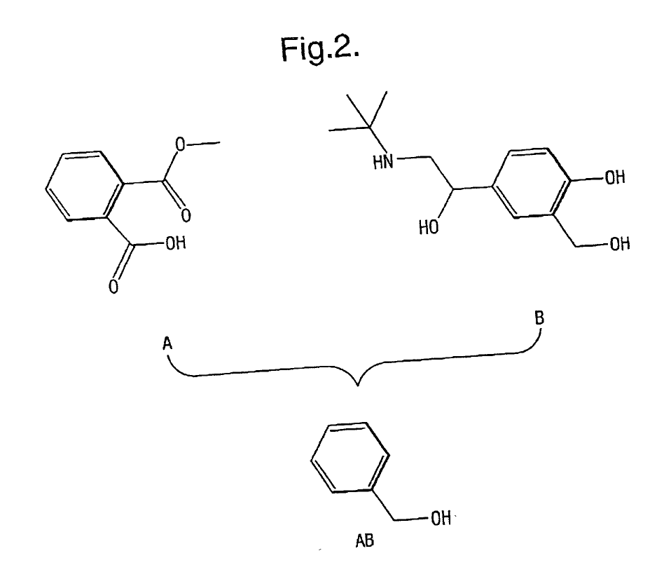

An example of an MCS fragment is shown in FIG. 2. Here, two parent molecules A and B are shown along with their common substructure AB. The common substructure AB comprises a benzene ring, where one carbon atom of the benzene ring is attached to a further carbon atom bonded to an alcohol group. In this particular example, the chemical context is not included as can be seen by a comparison with the parent molecules A and B. Referring to the carbon atom attached to the alcohol group, for the molecule A, the carbon atom is also double bonded to an oxygen atom whereas for the molecule B there are two separate bonds to hydrogen atoms.

Following the conversion of the MCS fragment into the file format, the next step is to determine whether the MCS fragment is new or whether it is merely a repetition of a fragment that is already known.

In this initial comparison of the first two molecules A, B, it is very likely that the MCS structure is not identical to the entire structure of any one of the other molecules within the original data set. However, during subsequent comparisons later on, the likelihood of an MCS fragment already being known greatly increases, although this is of course dependent upon the similarity between the molecules in the data set. During such later comparisons, the determined MCS fragments are also added to the original data set and are treated as new molecules.

At step 7, the MCS fragment mass is compared with each of the molecules within the original data set.

An initial comparison between the particular MCS fragment AB and the molecules in the data set is made by calculating the mass of the MCS fragment AB and the molecules in the data set. This is a real time summation in the present case, as of course the masses of the component atoms for each molecule can be obtained quickly from a look-up table of atomic masses.

If the MCS fragment is found to be new (having a unique mass) then it is stored for later addition to the data set at step 8. If the fragment has an identical mass to a molecule within the data set then a structural comparison is performed at step 9 in a similar manner to steps 3 to 6. If the resultant new maximum common substructure between the fragment AB and one of the molecules having an identical mass, has the same structure as the molecule, then the structure is not stored.

As has been stated, each molecule within the data set is represented as an individual file. Within each file there exists a list of parent structures for each structure (molecule or MCS fragment) within the database. In the case of each molecule, there are no parent structures, however the identity of the molecule itself is held within the parent list as this list is used to avoid unnecessary comparisons between structures which have already been compared.

When a new MCS fragment is stored at step 8 a parent list for this fragment is created in the corresponding file and this list contains the identity of the two parents for the particular MCS fragment. Therefore for the fragment AB, the parent list contains the molecules A and B. In the case of MCS fragments that are identical to those which already exist, although the MCS fragment is not stored, the identity of its parents are added to the parent list of the already stored fragment at step 10.

As will be described, at later stages within the method, the MCS fragments are often parents themselves and therefore in such cases the entire parent tree list for the MCS fragments, including all previous generations of parents, are then stored with the MCS respective fragment. This occurs either if the MCS fragment is stored as a new fragment or if it is an old fragment, in which case the already existing fragment parent list is updated.

The procedure between step 3 and 11 is then repeated for each pairwise combination of the molecules within the working area and any corresponding MCS fragments that are found are stored. Again, any fragments which are identical to a fragment already within the data set are not stored although the corresponding parent list of the fragment in the data set is updated with the parent tree of the duplicate structure.

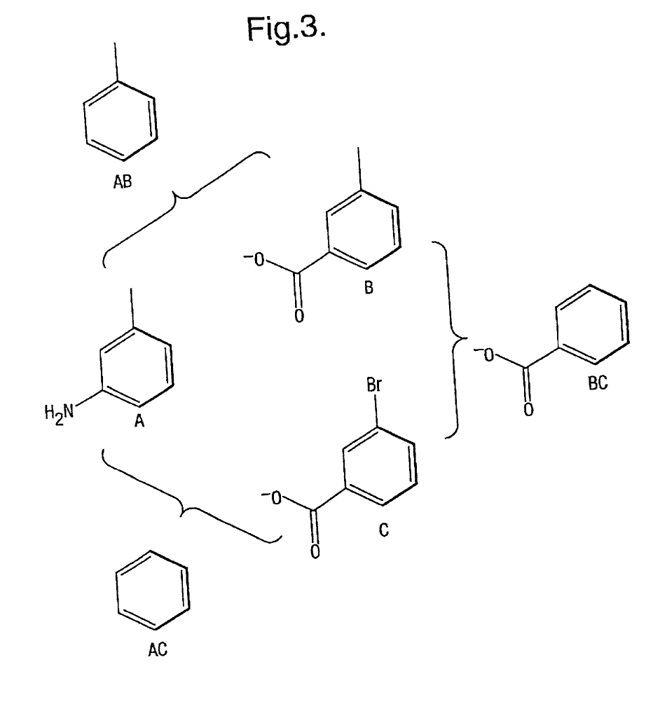

FIG. 3 shows three molecules within the data set, that is A, B and C. The MCS fragment for each pairwise combination of these molecules is also shown as AB, AC and BC. In this case, three parent molecules produce three MCS fragments. In general, N molecules will give rise to (N²-N)/2 MCS fragments.

Once steps 3 to 10 have been repeated for each pairwise combination of the molecules in the data set, the newly discovered fragments are added to the data set at step 11.

The process is then started again at step 12 using the new data set as a working group, the new data set comprising not only the original molecules A, B, . . . , but also the new MCS fragments AB, C . . . found in the last iteration. Steps 2 to 11 are repeated such that pairwise combinations of MCS fragments are then found for all structures within the new data set, that is the molecules and the MCS fragments such as AB.

This is achieved as in the previous iteration, by copying the data set to the working area and generating the MCS fragment combinations such as fragment AB with the original molecule C and the fragment AC with the fragment BC, and so on. At each stage the parent lists are updated with the new fragments stored or those already existing are updated when duplicates are found. In addition, at each stage the number of new structures found is monitored. The process ends at step 13 when no new MCS fragments are found.

Once the process has been completed, the fragments are ranked at step 14 by analysing the parent lists. Only fragments containing parent lists with three parents or more are retained within the data set, and the remainder are deleted. This of course removes any original molecules that were not found to be actual MCS fragments of other molecules. Typically this reduces the number of fragments by an order of magnitude and in the present case around 500 fragments remain from a typical database of 300 drug molecules. The number of fragments is of course dependent upon not only the size of the original data set of molecules but also the structural similarities between them. As a result of this reduction, an MCS fragment database has been generated for use in further modelling steps.

As will be appreciated, the MCS fragments determined are therefore not all the possible fragments within all the molecules but those being determined from a maximum common substructure (MCS) limitation. Nevertheless those that are found according to this example typically represent a broad spectrum of MCS fragment sizes.

It is known generally that small fragments, which are very common within molecules such as a CH₂ group, provide general organic properties for molecules (in this case a hydrophobic property). In contrast, the larger MCS fragments tend to contain highly drug specific properties and, importantly, there is also a spectrum between these two extremes.

The method described above can be conveniently used to find a whole spectrum of these fragments. This is extremely advantageous in that modelling of a whole range of properties can therefore be performed upon this one database. Alternatively the database may be modified to filter out particular well known organic or drug specific properties.

Once the database of fragments has been generated, in order to determine which fragments influence the properties of the various molecules, each of the molecules in the original predetermined data set is then analysed to determine which fragments of the database it actually contains. This comparison process will now be described.

At step 15, the first molecule A is loaded from the original data set and a procedure similar to that described earlier is used to deduce the maximum common substructure shared between this molecule and that of the first fragment in the database. If a maximum common substructure (MCS) is found between the fragment and the molecule A then the atoms within the MCS are removed from the molecule A at step 16. A count is updated to indicate that one such fragment has already been found. This is then repeated using the remaining atoms until no more maximum common substructures can be found within the same module.

For example if the fragment with which the molecule A was compared was in fact a benzene ring, then if there were three benzene rings within the molecule A the resultant fragment count for the first fragment would be three.

One important aspect of this approach is that partial fragments can be found using this method, for example for 4 atoms of a benzene ring. Therefore fractional (non-integer fragment) counts are possible and these provide a great deal of further information for any subsequent modelling process used. It should also be noted that a particular partial fragment may be identical to a smaller full fragment. During later modelling this provides information as to the confidence that may be placed in the influence of specific fragments.

At step 17 the steps 15 and 16 are repeated for all the further fragments within the database. As described earlier, the chemical context in this situation can also be either turned on or turned off.

This process is repeated for each of the molecules within the original data set (step 18) such that a fragment count is performed upon each fragment for every molecule.

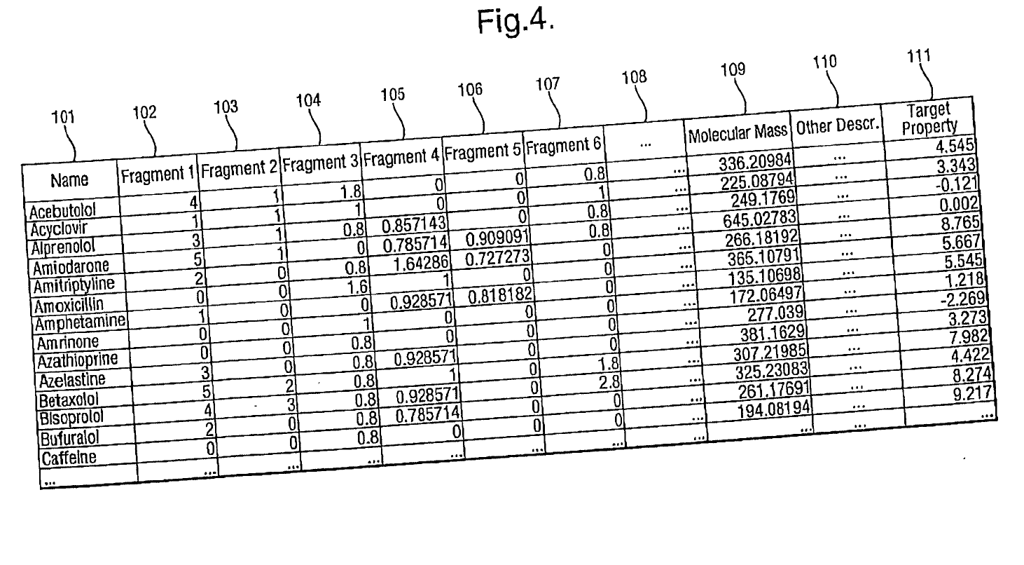

An example of a database 100 generated according to this example is shown schematically in FIG. 4. The database 100 has a “Name” column 101 identifying each of the predetermined molecules in the original data set. The last row in the column 101 indicates the presence of many more molecules within the column 101.

A number of “Fragment” columns 102 to 107 are provided which contain data describing the number of occurrences of the fragments within each of the molecules detailed in the “Name” column 101. These fragments represent each of the fragments determined by the method described above after the ranking has been performed and the less frequently occurring fragments have been discarded. As shown in FIG. 4, some of these columns 102 to 107 contain only integer data whereas others contain non-integer data representing partial fragment occurrences within the molecules in column 101. Only six fragment columns are shown within FIG. 4, whereas in reality there are many more and these are indicated generally by the column 108.

A further column 109 provides “Molecular Mass” data for each of the molecules. This is an example of the use of a conventional descriptor in conjunction with the fragments generated by the method described above. The presence of further conventional descriptors is generally represented at column 110. Other examples of such conventional descriptors include atom counts or QSAR descriptors such as electrostatic, volumetric or topological properties.

The final column 111 contains data relating to a specific biological target characteristic which is desired to be modelled. The data within this column are predetermined and are used in the training of the model such as an artificial neural network. The purpose of the modelling is to predict a value for this target characteristic in respect of a “target” molecule that has not been considered during the model training.

The example method described is extremely processor intensive and therefore a high performance computer system is desirable for implementing this method. In a practical example, when the method was performed upon a library of 174 drugs, over 15000 pairwise fragments were found. About 130 million scans were performed to identify duplicates which resulted in about 7000 unique MCS fragments being identified. About 370 of these fragments were found to occur more than twice and these can be considered to be information rich fragments. The massive number of calculations required to identify these 370 or so fragments occupied a high performance desk top computer for about 4 days.

However, once the fragments have been identified they are extremely useful for modelling purposes. Any suitable modelling technique can be used and typically genetic programming and neural network models have proved to be successful in accurately identifying fragments which are important in influencing the specific biological effects of such drug molecules. One or more of these fragments are generally identified as being important. Returning to FIG. 1, a model is run upon the database at step 19 in order to determine a relationship between the data describing the occurrence and identity of the fragments within the molecules, and the common biological target characteristic (in this case a target biological property value).

Subsequently, the “trained” model, that is, having determined a relationship, is used to determine the target property value for an “unknown” target molecule (that is, a molecule not contained within the original data set). The target molecule is selected at step 20.

In order to determine which of the fragments of molecular structure are present within this molecule, the method of steps 15 to 17 can be performed upon the new molecule by comparing it with every fragment within the database, or at least those fragments that have been identified by the modelling for use in making predictions of the biological property. This occurs at step 21 and provides a count including non-integer values, of the fragment types within the new molecule.

Once the presence of the particular fragments have been identified, the relationship can be used to rapidly predict a value for the biological target property of interest (step 22). The final output in this example is therefore a predicted value for the biological target property exhibited by the unknown molecule (step 23).

1. A method of generating a database of molecular fragment data, the molecular fragment data defining at least parts of a number of molecular structures, from a data set retained within a store, the data set containing predetermined molecular structure data defining a number of predetermined molecular structures, the method comprising:
a) selecting first and second molecular structure data defining first and second molecular structures respectively from the data set;
b) comparing the selected first and second molecular structure data to determine molecular fragment data, wherein the molecular fragment data defines at least part of a molecular structure common to each of the first and second molecular structures;
c) storing the determined molecular fragment data in the data set; and,
d) repeatedly performing steps (a) to (c) wherein either of the first or the second molecular structure data is selected from either the predetermined molecular structure data or the molecular fragment data determined in step (b) such that the resultant data set comprises a database containing the molecular fragment data.

2. A method according to claim 1, wherein the molecular fragment data determined in step (b) defines the maximum molecular structure common to the first and second molecular structures.

3. A method according to claim 2, wherein the maximum common structure is the maximum common molecular substructure between the first and second molecular structures.

4. A method according to claim 2 or claim 3, wherein the maximum common structure is the maximum molecular structure of atoms bonded as a single connected entity.

5. A method according to any of the preceding claims, further comprising a step of comparing the molecular fragment data determined in step (b) with the molecular structure data already within the data set and subsequently storing the determined molecular fragment data only if molecular structure data defining an identical molecular structure is not already present within the data set.

6. A method according to claim 5, wherein the comparison between the determined molecular fragment data and the molecular structure data is based upon the molecular masses of the corresponding molecular fragment and the molecular structure respectively.

7. A method according to any of the preceding claims, wherein the determined molecular fragment data comprises data identifying the first or second molecular structure data which has been involved in any previous comparison steps which have resulted in the determination of that particular molecular fragment data.

8. A method according to claim 7, wherein the identifying data is retained as a parent list identifying the molecular structure data.

9. A method according to claims 7 or claim 8, and when dependent upon claim 5, wherein, if the determined molecular fragment as defined by the molecular fragment data, is found to be identical to a molecular structure as defined by corresponding molecular structure data already present within the data set, the identifying data is added to the molecular structure data defining the molecular structure that is already present within the data set.

10. A method according to any of the preceding claims wherein step (b) is performed using a method according to graph theory.

11. A method according to claim 10, wherein the method of performing step (b) in accordance with graph theory comprises:
i) converting the first and second molecular structure data to first and second coloured graphs;
ii) determining a docking graph from the first and second graphs;
iii) identifying at least one clique within the docking graph; and
iv) converting each clique identified into molecular fragment data.

12. A method according to any of the preceding claims, further comprising ranking the molecular structure data in the data set according to the frequency with which molecular structures identical to each particular molecular structure have been determined, and discarding the molecular structure data defining molecular structures which occur less frequently than a predetermined frequency threshold.

13. A method according to claim 13, wherein only a number of the molecular fragment data are retained within the database.

14. A method according to any of the preceding claims, further comprising:
f) comparing the molecular fragment data in the database with molecular structure data defining each of the predetermined molecular structures; and
g) determining the frequency of occurrence of each molecular fragment within each predetermined molecular structure.

15. A method according to claim 14, wherein the frequency includes fractional frequencies based upon the fraction of a particular molecular fragment present within a particular molecular structure.

16. A method according to claim 15, wherein the frequency of occurrence is determined for a particular predetermined molecular structure by:
i) selecting the molecular structure data defining the particular predetermined molecular structure;
ii) selecting molecular fragment data representing a particular molecular fragment from the data set;
iii) comparing the selected molecular structure data and the molecular fragment data to determine common structure data representing the structure common to the predetermined molecular structure and the selected molecular fragment;
iv) determining the amount of the molecular fragment structure that the common structure data represents;
v) removing the determined common structure data from the predetermined molecular structure data; and
vi) repeatedly performing steps (iii) to (v) until no further common structure data is determined.

17. A method according to claim 16, wherein the comparison step (iii) is performed using a graph theory method.

18. A method of determining a relationship between the presence of a number of molecular fragments in a number of molecular structures and a biological target characteristic of the molecular structures, the method comprising:
obtaining a modelling data set comprising data defining the molecular structures of a number of known molecules and corresponding known biological target characteristic data defining a common biological target characteristic for each molecule;
obtaining a database of molecular fragments data generated using a method according to any of the preceding claims;
obtaining data describing the presence of the molecular structures defined by the molecular fragment data, within the known molecules of the modelling data set; and,
determining a relationship between the data describing the presence of a number of the molecular fragments within the known molecules of the modelling data set and the common biological target characteristic data.

19. A method according to claim 18, wherein a number of the known molecules have identical structures to a number of the molecular structures used in the generation of the molecular fragment data.

20. A method according to claim 18 or claim 19, wherein the step of determining the relationship is performed using a numerical model.

21. A computer implemented method of generating predicted biological target characteristic data for a target molecule, the method comprising:
obtaining target molecular structure data defining the molecular structure of the target molecule;
obtaining the relationship generated in the method according to any of claims 18 to 20;
processing the target molecular structure data to generate target fragment data describing the presence within the target molecule, of the molecular structures defined by the molecular fragment data used in the obtained relationship; and,
using the obtained relationship and the target fragment data to generate biological target characteristic data for the target molecule.

22. A method according to claim 21, wherein the molecular structure of the target molecule is different to the molecular structures of the known molecules or the molecules used in the generation of the molecular fragment data.

23. A method of determining a relationship between the presence of a number of molecular fragments in a number of molecular structures and a biological target characteristic, the method comprising:
obtaining a modelling data set comprising data defining the molecular structures of a number of known molecules and corresponding known biological target characteristic data defining a common biological target characteristic for each molecule;
obtaining a database of molecular fragment data;
obtaining data describing the frequency of occurrence of a number of the molecular structures defined by the molecular fragment data, within the known molecules of the modelling data set wherein the data contains at least one non-integer frequency of occurrence; and
determining a relationship between the data describing the frequency of occurrence of the molecular fragments within the known molecules of the modelling data set, and the common biological target characteristic data.

24. A method according to claim 23, wherein at least the non-integer frequency of occurrence is determined for the molecular structure of a particular known molecule:
i) selecting the molecular structure data defining the particular known molecule;
ii) selecting molecular fragment data representing a particular molecular fragment from the database;
iii) comparing the selected molecular structure data and the molecular fragment data to determine common structure data representing the structure common to the predetermined molecular structure and the selected molecular fragment;
iv) determining the amount of the molecular fragment structure that the common structure data represents;
v) removing the determined common structure data from the predetermined molecular structure data; and
vi) repeatedly performing steps (iii) to (v) until no further common structure data is determined.

25. A method according to claim 24, wherein the comparison step (iii) is performed using a graph theory method.

26. A method according to any of claims 23 to 25, wherein a number of the known molecules have identical structures to a number of the molecular structures used in the generation of the molecular fragment data.

27. A method according to any of claims 23 to 26, wherein the step of determining the relationship is performed using a numerical model.

28. A computer implemented method of genera ting biological target characteristic data for a target molecule, the method comprising:
obtaining target molecular structure data defining the molecular structure of the target molecule;
obtaining the relationship generated in the method according to any of claims 23 to 27;
processing the target molecular structure data to generate target fragment data describing the presence within the target molecule, of the molecular structures defined by the molecular fragment data used in the obtained relationship wherein the presence includes at least one non-integer frequency of occurrence; and,
using the obtained relationship and the target fragment data to generate biological target characteristic data for the target molecule.

29. A method according to claim 28, wherein the molecular structure of the target molecule is different to the molecular structures of the known molecules or the molecules used in the generation of the molecular fragment data.

30. A computer program comprising program code means adapted to perform the method according to any of preceding claims, when the computer program is run on a computer.

31. A computer program according to claim 30, embodied on a computer readable medium.
